(19) United States
(12) Patent Application Publication
(10) Pub. No.: US 2006/0096592 A1
(43) Pub. Date: May 11, 2006

(54) Protective ensemble comprising protective garment, face mask mounting respirator, and means for conducting exhaled gases into space within protective garment

(76) Inventors: William L. Grilliot, Dayton, OH (US); Mary I. Grilliot, Dayton, OH (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/147,085

(22) Filed: Jun. 7, 2005

Related U.S. Application Data
(63) Continuation-in-part of application No. 10/985,391, filed on Nov. 11, 2004.

(51) Int. Cl. A62B 17/04; A62B 18/00

(52) U.S. Cl. 128/201.22; 128/201.23; 128/201.24; 128/201.29

(57) ABSTRACT

For a firefighter or for an emergency rescue worker, a protective ensemble comprises a protective garment, such as a protective coat, a face mask, which mounts a respirator having an exhalation valve, a housing member, which is coupled to the exhalation valve, and a flexible conduit, which is coupled to the housing member for conducting exhaled gases from the exhalation valve of the respirator into a space within the protective garment. In one contemplated embodiment, the space within the protective garment is a space between layers of the protective garment. In an alternative embodiment, the space within the protective garment is a space between the protective garment and inner clothes of a wearer of the protective ensemble and between the bare skin of the wearer where said skin is not covered by inner clothes of the wearer.

### CROSS-REFERENCE TO RELATED APPLICATION

This application is a continuation-in-part of U.S. patent application Ser. No. 10/985,391, which was filed on Nov. 11, 2004, and the disclosure of which is incorporated herein by reference.

### TECHNICAL FIELD OF THE INVENTION

This invention pertains to a protective ensemble for a firefighter or for an emergency rescue worker, the protective ensemble comprising a protective garment and a face mask, which mounts a respirator having an exhalation valve. This invention contemplates that the protective ensemble is equipped with means for conducting exhaled gases from exhalation valve of the respirator into a space within the protective garment.

### BACKGROUND OF THE INVENTION

As disclosed in U.S. Pat. No. 5,572,991, the disclosure of which is incorporated herein by reference, a protective garment for a firefighter is worn with a self-contained breathing apparatus (SCBA) having a air tank and having a face mask, from which exhaled air is delivered to a space between adjacent layers of the protective garment, so as to ventilate the protective garment. The space is vented through openings provided between adjacent layers of the protective garment.

As disclosed in said patent, fresh air from an air tank of the self-contained breathing apparatus or fresh air or another gas, such as carbon dioxide, from a separate cannister can be also delivered to the space, either, via a restricted orifice allowing fresh air to bleed into the space, or rapidly via a valve, which is closed normally but which the firefighter can open, via a pull ring, when the firefighter is exposed to extreme heat.

As disclosed in U.S. patent application Ser. No. 10/985,391, supra, a protective garment, such as a protective coat, protective trousers, protective overalls, or protective coveralls, is equipped with means for maintaining positive gas pressure within a space between the protective garment and inner clothes where worn by the wearer within the protective garment and between the protective garment and bare skin of the wearer where said skin is not covered by inner clothes being worn by the wearer within the protective garment. Positive air pressure maintained within the space not only increases the thermal protective performance of the protective garment but also inhibits ingress of foreign gaseous and particulate materials, which may be potentially hazardous.

In one embodiment disclosed in said application, if the wearer carries a self-contained breathing apparatus including a supply of compressed air and including a face mask, which is arranged to intake air supplied by the supply for the wearer to breathe and to expel air exhaled by the wearer, the protective garment is equipped with means for directing air supplied by the supply and air exhaled by the wearer so as to maintain positive air pressure within a space between the protective garment and inner clothes where worn by the wearer within the protective garment and between the protective garment and bare skin of the wearer where said skin is not covered by inner clothes being worn by the wearer within the protective garment.

### SUMMARY OF THE INVENTION

This invention provided a protective ensemble comprising a protective garment, a face mask, which mounts a respirator having an exhalation valve, and means for conducting exhaled gases from the exhalation valve of the respirator into a space within the protective garment.

Preferably, the conducting means comprises a flexible conduit, which is arranged to conduct exhaled gases from the exhalation valve into the space within the protective garment. Preferably, moreover, the conducting means comprises a housing member, which is coupled to the exhalation valve and to which the flexible conduit is coupled.

Conceivably, the space within the protective garment is a space between layers of the protective garment. Alternatively, the space within the protective garment is a space between the protective garment and inner clothes of a wearer of the protective ensemble and between the bare skin of the wearer where said skin is not covered by inner clothes of the wearer. In either instance, exhaled gases conducted into the space within the protective garment help to ventilate the protective garment.

Whether a powered, air-purifying respirator (PAPR) which has a fan designed to draw air through the respirator into the face mask or a non-powered, air-purifying respirator (APR) which does not have such a fan, a respirator of a protective ensemble embodying this invention is distinguishable from a self-contained breathing apparatus (SCBA) because the respirator does not have an air supply, such as an air tank.

### BRIEF DESCRIPTION OF THE DRAWINGS

FIG. 1 is a pictorial view of a firefighter wearing a protective ensemble embodying this invention and comprising a protective garment, a face mask, which mounts a respirator having an exhalation valve, and means for conducting exhaled gases from the exhalation valve of the respirator into a space within the protective garment.

FIG. 2, on a larger scale, is a sectional view taken along line 2-2 of FIG. 1, in a direction indicated by arrows, to illustrate elements of the conducting means, namely, a housing member covering the exhalation valve and a flexible conduit coupled to the housing member.

FIG. 3, on a similar scale, is a sectional view taken along line 3-3 of FIG. 1, in a direction indicated by arrows, to illustrate one contemplated embodiment of this invention. FIG. 4, on a similar scale, is a sectional view taken similarly to illustrate an alternative embodiment of this invention.

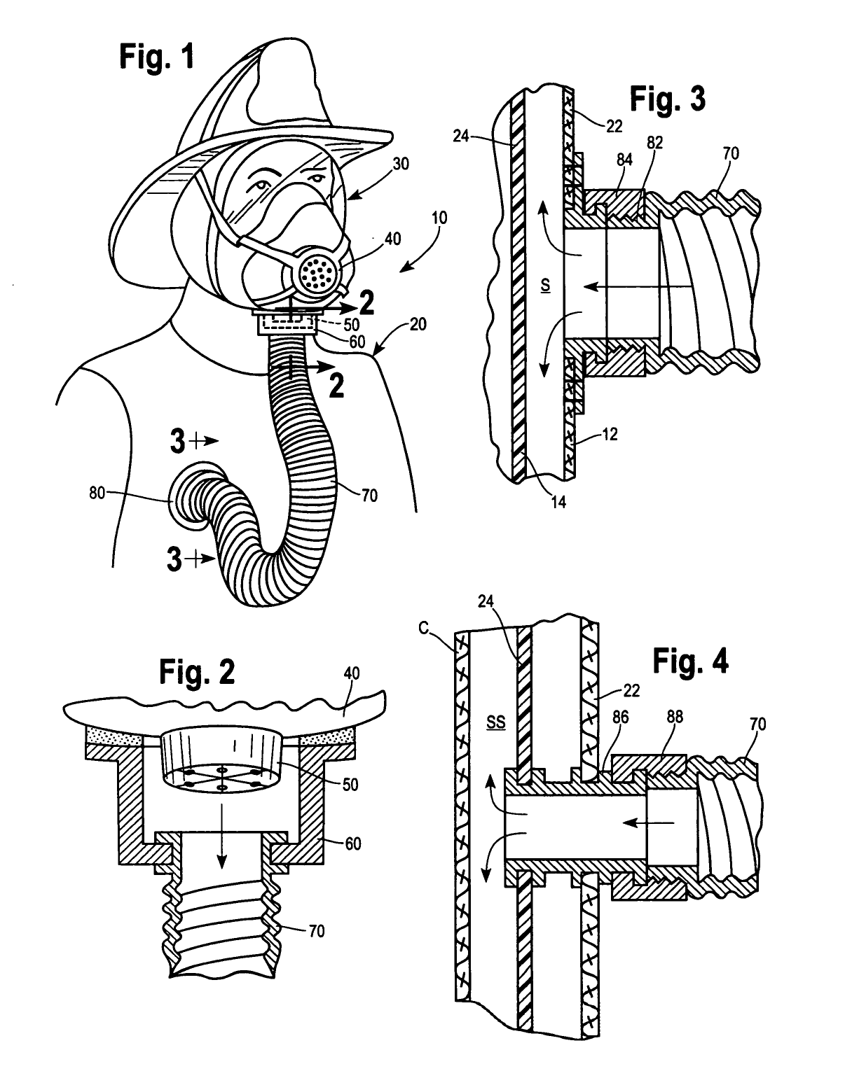

### DETAILED DESCRIPTION OF THE ILLUSTRATED EMBODIMENTS

A protective ensemble 10 worn by a firefighter, as illustrated, or by an emergency rescue worker comprises protective garments, which include a protective coat 20, a face mask 30, which mounts a respirator 40 having an exhalation valve 50, and means for conducting exhaled gases from the exhalation valve 50 into a space within the protective coat 20.

The protective coat 20 comprises an outer shell 12 and a lining system 14, which is illustrated schematically and which may include an intermediate liner providing a moisture barrier and an inner liner providing a thermal barrier. Preferably, the protective coat conforms to NFPA 1971 “Protective Ensemble for Structural Fire Fighting.”

As illustrated, the respirator 40 is a non-powered, air-purifying respirator (APR) which has a filter designed to filter contaminants from air breathed through the respirator by a wearer of the face mask 30. Alternatively, the respirator 40 is a powered, air-purifying respirator (PAPR) which also has a fan designed to draw air through the respirator into the face mask 30. In either instance, the exhalation valve 50 is designed to discharge gases exhaled by a wearer of the face mask 30, from the respirator 40.

As illustrated, the face mask 30 is a full face mask, which is designed to cover the eyes, nose, and mouth of the wearer. Alternatively, the face mask 30 is a half face mask, which is designed to cover the nose and mouth of the wearer but not the eyes of the wearer.

As illustrated, the conducting means comprises a housing member 60, which may be metallic, as illustrated, or polymeric, which if polymeric may be rigid or flexible, and which is secured adhesively, as illustrated, or otherwise suitably to the respirator 40 so as to cover the exhalation valve 50, and a flexible conduit 70, which is coupled to and between the housing member 60 and an aperture 80 in the protective coat 10. The flexible conduit 70, which is coupled to the housing member 60 via a fitting 72, is arranged to conduct exhaled gases from the exhalation valve 50 of the housing member 60, through the aperture 80, into a space within the protective coat 10.

In the embodiment illustrated in FIG. 2, the flexible conduit 70 extends through the outer shell 22 of the protective coat 20 and is secured at the aperture 80, via a fitting 82 receiving a locking nut 84, and opens into a space S between layers of the protective coat 20, i.e., between the outer shell 22 and the lining system 24. U.S. Pat. No. 5,572,991, supra, discloses a similar fitting and a similar locking nut, which are utilized similarly.

In the embodiment illustrated in FIG. 3, the flexible conduit 70 extends through the outer shell 22 of the protective coat 20 and through the lining system 14 of the protective coat 20 and is secured at the aperture 80, via a fitting 86 receiving a locking nut 88, and opens into a space SS between the protective coat 20 and inner clothes C of a wearer of the protective ensemble 10 and between the bare skin of the wearer where said skin is not covered by inner clothes C of the wearer.

Whether conducted into the space S in the embodiment illustrated in FIG. 2 or into the space SS in the embodiment illustrated in FIG. 3, exhaled gases conducted by the conducting means from the exhalation valve 50 of the respirator 40 help to ventilate the protective coat 20.

1. A protective ensemble comprising a protective garment, a face mask, which mounts a respirator having an exhalation valve, and means for conducting exhaled gases from the exhalation valve of the respirator into a space within the protective garment.

2. The protective ensemble of claim 1, wherein the space within the protective garment is a space between layers of the protective garment.

3. The protective ensemble of claim 1, wherein the space within the protective garment is a space between the protective garment and inner clothes of a wearer of the protective ensemble and between the protective garment and the bare skin of the wearer where said skin is not covered by inner clothes of the wearer.

4. The protective ensemble of claim 1, wherein the conducting means comprises a flexible conduit, which is arranged to conduct exhaled gases from the exhalation valve into the space within the protective garment.

5. The protective ensemble of claim 4, wherein the space within the protective garment is a space between layers of the protective garment.

6. The protective ensemble of claim 4, wherein the space within the protective garment is a space between the protective garment and inner clothes of a wearer of the protective ensemble and between the protective garment and the bare skin of the wearer where said skin is not covered by inner clothes of the wearer.

7. The protective ensemble of claim 4, wherein the conducting means comprises a housing member, which is coupled to the exhalation valve and to which the flexible conduit is coupled.

8. The protective ensemble of claim 5, wherein the conducting means comprises a housing member, which is coupled to the exhalation valve and to which the flexible conduit is coupled.

9. The protective ensemble of claim 6, wherein the conducting means comprises a housing member, which is coupled to the exhalation valve and to which the flexible conduit is coupled.
